(19) United States
(12) Patent Application Publication
(10) Pub. No.: US 2025/0209303 A1
(43) Pub. Date: Jun. 26, 2025

(54) NEURAL NETWORK CHIP IN AN EAR-WORN DEVICE FOR RESETTING STATES OF A NEURAL NETWORK LAYER

(71) Applicant: Chromatic Inc., New York, NY (US)

(72) Inventors: Philip Meyers, IV, San Francisco, CA (US); Davide Asnaghi, New York, NY (US)

(21) Appl. No.: 18/392,650

(22) Filed: Dec. 21, 2023

(51) Int. Cl. G06N 3/044; G06N 3/063

(52) U.S. Cl. CPC G06N 3/044; G06N 3/063

(57) ABSTRACT

An ear-worn device may comprise a neural network chip including memory, processing circuitry, and control circuitry. The memory may include a plurality of states registers. The control circuitry is configured to control the processing circuitry to perform neural network processing of an N-layer neural network using more than N of the plurality of states registers. In some embodiments, the memory may further include a plurality of pointers, and the control circuitry may be configured to control a first pointer of the plurality of pointers and a second pointer of the plurality of pointers to swap contents. In some embodiments, the control circuitry may be configured to control states in a first of the plurality of states registers to be replaced with states in a second states register of the plurality of states registers.

### BACKGROUND

The present disclosure relates to a neural network chip. Neural network chips may be used for running neural networks. Neural networks may be used, for example, in an ear-worn device for speech enhancement and/or noise reduction.

### SUMMARY

According to one aspect, a neural network chip includes: memory including a plurality of states registers and a plurality of pointers; processing circuitry; and control circuitry. The control circuitry is configured: at a first time, to control the processing circuitry to perform neural network processing of a layer of a neural network using states in a states register pointed to by a first pointer, where the states register pointed to by the first pointer is among the plurality of states registers, and the first pointer is among the plurality of pointers; at a second time subsequent to the first time, to control the processing circuitry to perform the neural network processing of the layer using the states in the states register pointed to by the first pointer and states in a states register pointed to by a second pointer, but only to include in an output of the layer a result of the neural network processing using the states in the states register pointed to by the first pointer, where the states register pointed to by the second pointer is among the plurality of states registers, and the second pointer is among the plurality of pointers; at a third time subsequent to the second time, to control the processing circuitry to perform the neural network processing of the layer using the states in the states register pointed to by the first pointer and the states in the states register pointed to by the second pointer, and to include in the output of the layer the result of the neural network processing using the states in the states register pointed to by the first pointer and a result of the neural network processing using the states in the states register pointed to by the second pointer; and at a fourth time subsequent to the third time, to control the first pointer and the second pointer to swap contents, or control the states in the states register pointed to by the first pointer to be replaced with the states in the states register pointed to by the second pointer.

In some embodiments, the control circuitry is configured: subsequent to the fourth time, to reset the states in the states register pointed to by the second pointer, or between the third and the fourth times, to reset the states in the states register pointed to by the first pointer.

In some embodiments, the memory further includes a plurality of stage registers; the layer is in a skip stage at the first time, is in a warmup stage at the second time, and is in a transition stage at the third time; and the stage register is configured to store that the layer is in the skip stage at the first time, in the warmup stage at the second time, and in the transition stage at the third time.

In some embodiments, the control circuitry is configured, at the third time, to perform a weighted sum of the result of the neural network processing using the states in the states register pointed to by the first pointer and the result of the neural network processing using the states in the states register pointed to by the second pointer by: applying a first weight to the result of the neural network processing using the states in the states register pointed to by the first pointer that transitions from 1 to 0 between the third time and the fourth time; and applying a second weight to the result of the neural network processing using the states in the states register pointed to by the second pointer transitions from 0 to 1 between the third time and the fourth time.

In some embodiments, the layer is in a transition stage at the third time, and a time between an end of the transition stage to an end of a subsequent transition stage for the layer is in a range of 1-30 seconds. In some embodiments, the layer is in a warmup stage at the second time and a transition stage at the third time, and a time from a beginning of the warmup stage to an end of the transition stage is in a range of 0.25-3 seconds

In some embodiments, the layer includes a first layer of the neural network, the neural network includes a second layer, and the neural network chip is configured to reset the first layer and the second layer at different times.

In some embodiments, the neural network includes a recurrent neural network.

In some embodiments, the processing circuitry does not perform the neural network processing using the states in the states register pointed to by the second register at the first time.

In some embodiments, the neural network includes N layers, and the neural network chip is configured to use an additional 100/N percent computing time compared to running the N-layer neural network without any resetting.

According to one aspect, a neural network chip includes: memory including a plurality of states registers and a plurality of pointers; processing circuitry; and control circuitry. The control circuitry is configured: at a first time, to control the processing circuitry to perform neural network processing of a layer of a neural network using states in a states register pointed to by a first pointer, where the states register pointed to by the first pointer is among the plurality of states registers, and the first pointer is among the plurality of pointers; at a second time subsequent to the first time, to control the processing circuitry to perform the neural network processing of the layer using the states in the states register pointed to by the first pointer and states in a states register pointed to by a second pointer, but only to include in an output of the layer a result of the neural network processing using the states in the states register pointed to by the first pointer, where the states register pointed to by the second pointer is among the plurality of states registers, and the second pointer is among the plurality of pointers; at a third time subsequent to the second time, to control the processing circuitry to perform the neural network processing of the layer using the states in the states register pointed to by the first pointer and the states in the states register pointed to by the second pointer, and to include in the output of the layer the result of the neural network processing using the states in the states register pointed to by the first pointer and a result of the neural network processing using the states in the states register pointed to by the second pointer; at a fourth time subsequent to the third time, to control the processing circuitry to the perform neural network processing of the layer of the neural network using the states in the states register pointed to by the second pointer, at a fifth time subsequent to the fourth time, to control the processing circuitry to perform the neural network processing of the layer using the states in the states register pointed to by the second pointer and the states in the states register pointed to by the first pointer, but only to include in the output of the layer the result of the neural network processing using the states in the states register pointed to by the second pointer; and at a sixth time subsequent to the fifth time, to control the processing circuitry to perform the neural network processing of the layer using the states in the states register pointed to by the second pointer and the states in the states register pointed to by the first pointer, and to include in the output of the layer the result of the neural network processing using the states in the states register pointed to by the first second and the result of the neural network processing using the states in the states register pointed to by the first pointer.

In some embodiments, the control circuitry is configured, subsequent to the fourth time, to reset the states in the states register pointed to by the first pointer.

In some embodiments, the memory further includes a plurality of stage registers; the layer is in a skip stage at the first time, is in a warmup stage at the second time, and is in a transition stage at the third time; and the stage register is configured to store that the layer is in the skip stage at the first time, in the warmup stage at the second time, and in the transition stage at the third time.

In some embodiments, the control circuitry is configured, at the third time, to perform a weighted sum of the result of the neural network processing using the states in the states register pointed to by the first pointer and the result of the neural network processing using the states in the states register pointed to by the second pointer by: applying a first weight to the result of the neural network processing using the states in the states register pointed to by the first pointer that transitions from 1 to 0 between the third time and the fourth time; and applying a second weight to the result of the neural network processing using the states in the states register pointed to by the second pointer transitions from 0 to 1 between the third time and the fourth time.

In some embodiments, the layer is in a first transition stage at the third time and in a second transition stage at the sixth time, and a time between an end of the first transition stage to an end of the second transition stage for the layer is in a range of 1-30 seconds. In some embodiments, the layer is in a warmup stage at the second time and a transition stage at the third time, and a time from a beginning of the warmup stage to an end of the transition stage is in a range of 0.25-3 seconds

In some embodiments, the layer includes a first layer of the neural network, the neural network includes a second layer; and the neural network chip is configured to reset the first layer and the second layer at different times.

In some embodiments, the neural network includes a recurrent neural network.

In some embodiments, the processing circuitry does not perform the neural network processing using the states in the states register pointed to by the second register at the first time.

In some embodiments, the neural network includes N layers, and the neural network chip is configured to use an additional 100/N percent computing time compared to running the N-layer neural network without any resetting.

According to one aspect, a neural network chip includes: memory including a plurality of states registers; processing circuitry; and control circuitry. The control circuitry is configured to control the processing circuitry to perform neural network processing of an N-layer neural network using more than N of the plurality of states registers.

According to one aspect, a neural network chip includes: memory including a plurality of states registers and a plurality of pointers; processing circuitry; and control circuitry. The control circuitry is configured to control a first pointer of the plurality of pointers and a second pointer of the plurality of pointers to swap contents.

According to one aspect, a neural network chip includes: memory including a plurality of states registers; processing circuitry; and control circuitry. The control circuitry is configured to control states in a first of the plurality of states registers to be replaced with states in a second states register of the plurality of states registers.

In any of the above aspects, an ear-worn device may include the neural network chip. In some embodiments, the ear-worn device may be a hearing aid, cochlear implant, or earphone.

### BRIEF DESCRIPTION OF DRAWINGS

Various aspects and embodiments of the application will be described with reference to the following figures. It should be appreciated that the figures are not necessarily drawn to scale.

Items appearing in multiple figures are indicated by the same reference number in all the figures in which they appear.

FIG. 1 illustrates a schematic of neural network processing using two sets of states, in accordance with certain embodiments described herein;

FIG. 2 illustrates an example reset schedule for a layer, in accordance with certain embodiments described herein;

FIG. 3 illustrates an example reset schedule for a layer, in accordance with certain embodiments described herein;

FIG. 4 illustrates a neural network chip, in accordance with certain embodiments described herein;

FIG. 5 illustrates a neural network chip, in accordance with certain embodiments described herein;

FIG. 6 illustrates a neural network chip, in accordance with certain embodiments described herein;

FIG. 7 illustrates a process for operating a neural network chip, in accordance with certain embodiments described herein;

FIG. 8 illustrates an example of schedules for four layers, in which only one layer resets at a time, in accordance with certain embodiments described herein;

FIG. 9 illustrates an example, with reference to FIG. 4, of which states registers the pointers point to assuming the process of FIG. 7 and the schedule of FIG. 8 are followed, in accordance with certain embodiments described herein;

FIG. 10 illustrates an example, with reference to FIG. 5, of which states registers the pointers point to assuming the process of FIG. 7 and the schedule of FIG. 8 are followed, in accordance with certain embodiments described herein;

FIG. 11 illustrates an example, with reference to FIG. 6, of which states registers the pointers point to assuming the process of FIG. 7 and the schedule of FIG. 8 are followed, in accordance with certain embodiments described herein;

FIG. 12 illustrates a process for operating a neural network chip, in accordance with certain embodiments described herein;

FIGS. 13A and 13B illustrate a process for operating a neural network chip, in accordance with certain embodiments described herein;

FIG. 14 illustrates an example of schedules for four layers, in which only one layer resets at a time, in accordance with certain embodiments described herein;

FIG. 15 illustrates an example hearing aid, in accordance with certain embodiments described herein; and

FIG. 16 illustrates an example of a hearing aid worn by a user, in accordance with certain embodiments described herein.

### DETAILED DESCRIPTION

For certain neural networks, such as recurrent neural networks (RNN), the result of processing at one time step may affect the processing at a subsequent time step. Such neural networks thus have states that can persist from one time step to another, and represent context information derived from processing of one or more previous inputs.

Stateful neural networks may suffer from drawbacks. Over time, states in a neural network may evolve into sets of values they never attained during training. As a result, the neural network may suffer degradation in performance or exhibit unpredictable behavior over time. Such degradation in performance over the long term may be avoided by resetting certain states of the neural network. In other words, it may be helpful to run a neural network under the conditions in which it was trained, to avoid potentially unconditioned behavior and/or outputs. A neural network may be trained on scenarios that are approximately X seconds long, but during actual operation the neural network may be on for much longer than X seconds (e.g., hours). For example, an ear-worn device such as a hearing aid may run a neural network for an entire day.

Resetting the neural network approximately every X seconds may maximize real-world performance by replicating the training environment as closely as possible. Resetting in this manner, however, may come with the drawback that, immediately after resetting the states, performance of the neural network may be degraded because the neural network is operating without the benefit of the context information derived from processing prior inputs. Therefore, although resetting the states may address the problem of states evolving to values they never attained during training, a different problem is created.

The inventors have discovered that to address both problems with stateful neural networks, two states for a given layer of a neural network may run in parallel using the same inputs, but the two states may be reset at times offset from each other. In this manner, the problem of long-term degradation can be avoided, as at any given point in time at least one of the states for the layer may have acquired meaningful information aiding in calculation of its output. The different results of the neural network processing attributable to the different states used for the layer may be combined such that the combined output utilizes more heavily, or exclusively, the result from a state or states that are at an optimal point of processing. The neural network may thus reduce its reliance on states that are at a non-optimal point. For example, the weight for the result of processing using states that have been reset more recently may be lower than the weight for the result of processing using states that have been reset less recently. Further description of resetting neural networks may be found in U.S. Pat. No. 11,838,727, titled HEARING AIDS WITH PARALLEL NEURAL NETWORKS, and issued on Dec. 5, 2023, which is incorporated by reference herein in its entirety.

One application of stateful neural networks is in ear-worn devices, such as hearing aids, cochlear implants, and earphones, which receive an input acoustic signal, amplify the signal, and output it to the wearer. Their performance can be improved by utilizing neural networks, for example to denoise audio signals. Further description of such neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety. In some embodiments, parallel states for a neural network as described herein may be implemented in an ear-worn device such as a hearing aid.

Deploying audio enhancement techniques may introduce delays between when a sound is emitted by the sound source and when the enhanced sound is output to a user. For example, such techniques may introduce a delay between when a speaker speaks and when a listener hears the enhanced speech. During in-person communication, long latencies can create the perception of an echo as both the original sound and the enhanced version of the sound are played back to the listener. Additionally, long latencies can interfere with how the listener processes incoming sound due to the disconnect between visual cues (e.g., moving lips) and the arrival of the associated sound.

The inventors have recognized that, to attain tolerable latencies when implementing a neural network on an ear-worn device, the ear-worn device would need to be capable of performing billions of operations per second. To address power issues with such demanding requirements, the neural network may be implemented on a neural network chip in the ear-worn device. Further description of neural network chips may be found in U.S. patent application Ser. No. 18/232,854, titled NEURAL NETWORK CHIP FOR EAR-WORN DEVICE, and filed on Aug. 11, 2023, which is incorporated by reference herein in its entirety. Described herein are circuitry and methods developed by the inventors for resetting parallel states in a neural network on a neural network chip.

The aspects and embodiments described above, as well as additional aspects and embodiments, are described further below. These aspects and/or embodiments may be used individually, all together, or in any combination of two or more, as the disclosure is not limited in this respect.

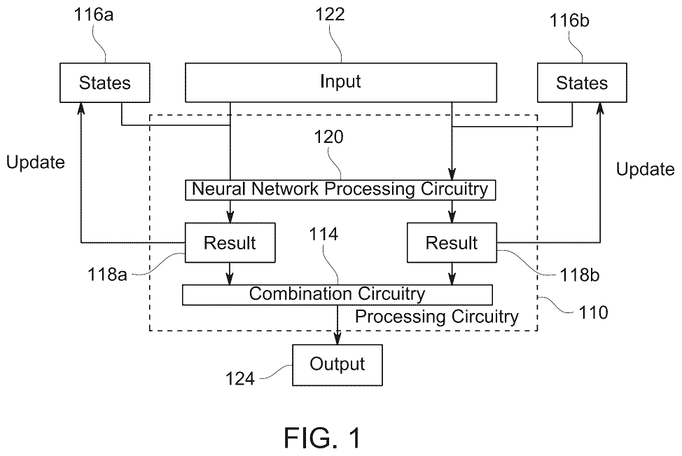

FIG. 1 illustrates a schematic of neural network processing using two sets of states, in accordance with certain embodiments described herein. FIG. 1 illustrates an input 122, one set of states 116a, another set of states 116b, processing circuitry 110, and an output 124. The processing circuitry 110 includes neural network processing circuitry 120 and combination circuitry 114. The neural network processing circuitry 120 may be circuitry configured to perform operations for processing an input through a neural network. Such operations may include addition, multiplication, convolution, and/or other nonlinear functions. The neural network processing circuitry 120 may be reused for processing each layer of the neural network one after another. The states 116a and 116b may be based on processing performed at a previous time step or be populated with previously determined initial values, and the input 122 may be an input from the current time step. The processing circuitry 110 may combine the states 116a and the input 122, and the neural network processing circuitry 120 may process the combination to produce a result 118a. The result 118a may be used to update the states 116a with new values. The processing circuitry 110 may combine the states 116b and the input 122, and the neural network processing circuitry 120 may process the combination to produce a result 118b. The result 118b may be used to update the states 116b with new values. The combination circuitry 114 may be configured to combine the result 118a and the result 118b to produce an output 124 of the layer of the neural network currently being processed. The output 124 may either be used as the input 122 to a subsequent layer in the neural network, or be taken as the output of the entire neural network.

The states 118a and the states 118b may each reset at different times. The result 118a and the result 118b may be combined (by the combination circuitry 114) such that the combined output 124 utilizes more heavily, or exclusively, the result from states that are at an optimal point of processing. Such a combination may include a weighted sum of the result 118a and the result 118b. In some embodiments, if the states 118b were more recently reset, then the weight applied to the result 118b may transition from 0 to 1 over time, while the result 118a may transition from 1 to 0 over time.

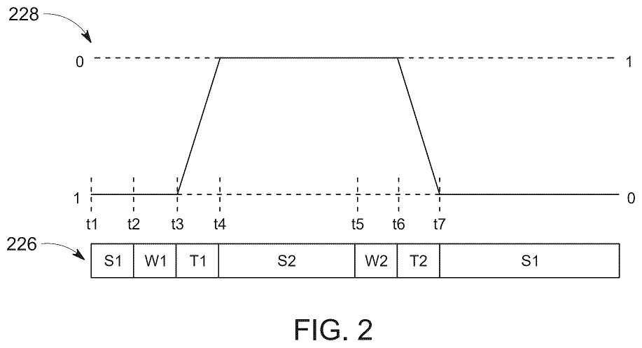

FIG. 2 illustrates an example reset schedule for a layer, in accordance with certain embodiments described herein. FIG. 2 includes a reset schedule 226 and a weighting schedule 228. The weighting schedule 228 shows the weight applied to the result 118a using the axis on the left and the weight applied to the result 118b using the axis on the right. At t1, only the states 116a are processed by the processing circuitry 110. The weight applied to the result 118a is 1. The layer may be considered to be in a “skip” stage of type 1 (“S1”), in which neural network processing is performed on the states 116a and neural network processing using the states 116b is skipped. At t2, the layer enters the “warmup” stage of type 1 (“W1”), in which both the states 116a and the states 116b are processed by the processing circuitry 110, but only the result 118a from processing using the states 116a is included in the output 124 of the layer. In other words, as shown by the weighting schedule 228, the weight applied to the result 118a by the combination circuitry 114 is 1 and the weight applied to the result 118b by the combination circuitry 114 is 0. At some point prior to the W1 stage, the states 118b may have been reset. Conceptually, at time t2, the states 116a may have degraded and the result 118a may need to be transitioned out from inclusion in the output 124 of the layer. The W1 stage may allow the recently-reset states 116b to attain meaningful values before the result 118b transitions into inclusion in the output 124 of the layer. At t3, the layer enters the “transition” stage of type 1 (“T1”), in which the result 118b from processing using the states 116b transitions into inclusion in the output 124. Thus, during the T1 stage, the weight applied to the result 118b by the combination circuitry 114 transitions from 0 to 1 and the weight applied to the result 118a by the combination circuitry 114 transitions from 1 to 0. At t4, only the states 116b are processed by the processing circuitry 110. The weight applied to the result 118a is 1. The layer may be considered to be in a “skip” stage of type 2 (“S2”), in which neural network processing is performed on the states 116b and neural network processing using the states 116a is skipped. Additionally, after t4, the states 116a may be reset. As referred to herein, resetting states may refer to actively changing values to 0, or actively changing values to a different value other than zero. Additionally, as referred to herein, resetting states may refer to actively changing values immediately, or over a finite length of time. In the latter case, the reset may be smooth, such that the values decay over time to zero or to a different value. Additionally, resetting states may refer to only resetting certain of the states but not all the states. At t5, the layer enters the “warmup” stage of type 2 (“W2”), in which both the states 116b and the states 116a are processed by the processing circuitry 110, but only the result 118b from processing using the states 116b is included in the output 124 of the layer. In other words, as shown by the weighting schedule 228, the weight applied to the result 118b by the combination circuitry 114 is 1 and the weight applied to the result 118a by the combination circuitry 114 is 0. Conceptually, at time t5, the states 116b may have degraded and the result 118b may need to be transitioned out from inclusion in the output 124 of the layer. The W2 stage may allow the recently-reset states 116a to attain meaningful values before the result 118a transitions into inclusion in the output 124 of the layer. At t6, the layer enters the “transition” stage of type 2 (“T1”), in which the result 118a from processing using the states 116a transitions into inclusion in the output 124. Thus, during the T2 stage, the weight applied to the result 118a by the combination circuitry 114 transitions from 0 to 1 and the weight applied to the result 118b by the combination circuitry 114 transitions from 1 to 0. Following the T2 stage, the cycle repeats with the S1 stage again.

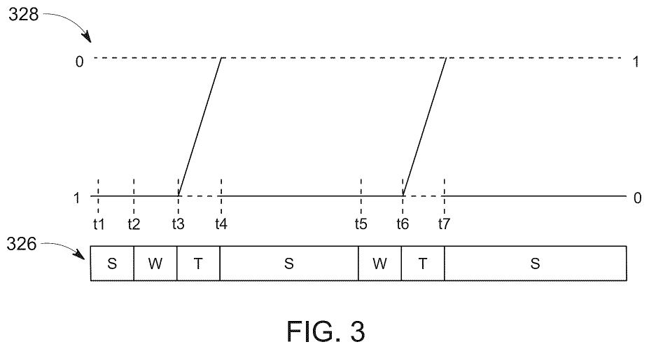

FIG. 3 illustrates an example reset schedule for a layer, in accordance with certain embodiments described herein. FIG. 3 includes a reset schedule 326 and a weighting schedule 328. The weighting schedule 328 shows the weight applied to the result 118a using the axis on the left and the weight applied to the result 118b using the axis on the right. At t1, only the states 116a are processed by the processing circuitry 110. The weight applied to the result 118a is 1. The layer may be considered to be in a “skip” stage (“S”), in which neural network processing is performed on the states 116a and neural network processing using the states 116b is skipped. At t2, the layer enters the “warmup” stage (“W”), in which both the states 116a and the states 116b are processed by the processing circuitry 110, but only the result 118a from processing using the states 116a is included in the output 124 of the layer. In other words, as shown by the weighting schedule 328, the weight applied to the result 118a by the combination circuitry 114 is 1 and the weight applied to the result 118b by the combination circuitry 114 is 0. Prior to the W stage, the states 118b may have been reset. Conceptually, at time t2, the states 116a may have degraded and the result 118a may need to be transitioned out from inclusion in the output 124 of the layer. The W stage may allow the recently-reset states 116b to attain meaningful values before the result 118b transitions into inclusion in the output 124 of the layer. At t3, the layer enters the “transition” stage (“T”), in which the result 118b from processing using the states 116b transitions into inclusion in the output 124. Thus, during the T stage, the weight applied to the result 118b by the combination circuitry 114 transitions from 0 to 1 and the weight applied to the result 118a by the combination circuitry 114 transitions from 1 to 0. At the conclusion of the transition stage, the states 116a are replaced with the states 116b, and the S stage starts again. As described above, in the S stage, only the states 116a (which were previously the states 116b) are processed by the processing circuitry 110. Additionally, once the states 116b have been copied to the states 116a, the states 116b may be reset. The W and T stages then occur again at t5 and t6, respectively, as described above.

It should be appreciated that the reset schedule 326 uses only three types of stages (S, W, and T) whereas the reset schedule 226 uses six (S1, W1, T1, S2, W2, and T2). This reduction in the types of stages is due to replacing the states 116a with the states 116b as described above. In contrast to the reset schedule 326, the reset schedule 226 does not include replacing states.

In some embodiments, replacing the states 116a with the states 116b may be accomplished by replacing the contents of a register storing the states 116a with the contents of a register storing the states 116b. In some embodiments, replacing the states 116a with the states 116b may be accomplished by swapping the contents of a pointer pointing to the register storing the states 116a with the contents of a pointer pointing to the register storing the states 116b.

As referred to herein, resetting states may refer to actively changing values to 0, or actively changing values to a different value other than zero. Additionally, as referred to herein, resetting states may refer to actively changing values immediately, or over a finite length of time. In the latter case, the reset may be smooth, such that the values decay over time to zero or to a different value. Additionally, resetting states may refer to only resetting certain of the states but not all the states.

The length of a skip stage may be an estimate of how long it takes for states to degrade and require a reset. Each stage may extend over multiple runs through the whole neural network. For example, assume that the length of time for the processing circuitry 110 to perform neural network processing of all layers of a neural network (a “run” through the neural network) is approximately 2 milliseconds. Assume further that it takes approximately 10 seconds for the states of a layer to degrade. Then, a skip stage may extend, for example, for approximately 8 seconds, or approximately 4000 runs through the neural network, and the following warmup and transition stages may each extend, for example, for approximately 1 second, or approximately 500 runs through the neural network. If a reset is measured from the end of a transition stage to the end of a subsequent transition stage, then a reset may occur for the layer every 10 seconds.

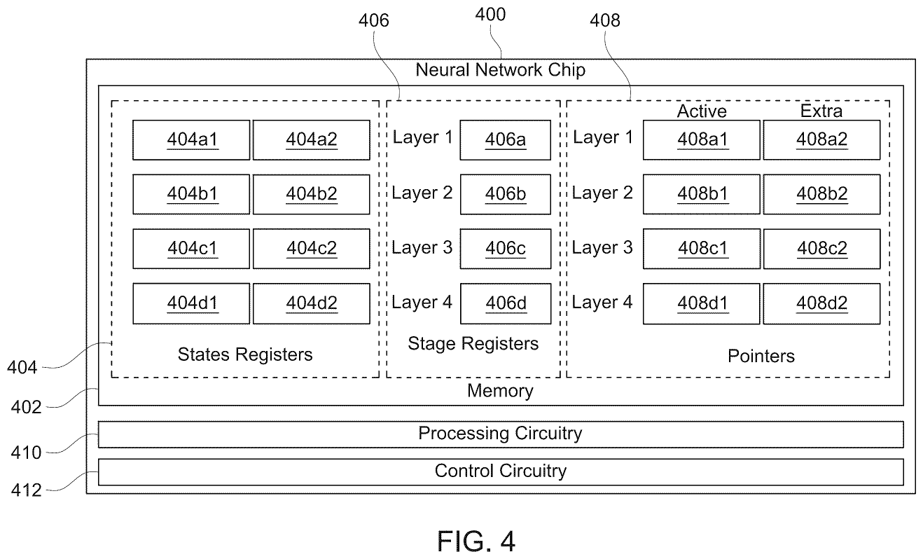

FIG. 4 illustrates a neural network chip 400, in accordance with certain embodiments described herein. The neural network chip 400 includes memory 402, processing circuitry 410 (which may be the same as the processing circuitry 110), and control circuitry 412. It should be appreciated that the neural network chip 400 may include more elements than illustrated. The memory 402 includes a plurality of states registers 404, a plurality of stage registers 406, and a plurality of pointers 408. The states registers 404 include the state registers 404a1, 404a2, 404b1, 404b2, 404c1, 404c2, 404d1, and 404d2. The stage registers 406 include the stage registers 406a, 406b, 406c, and 406d. The stage register 406a is associated with layer 1 of the neural network. The stage register 406b is associated with layer 2 of the neural network. The stage register 406c is associated with layer 3 of the neural network. The stage register 406d is associated with layer 4 of the neural network. The pointers 408 include the pointers 404a1, 404a2, 404b1, 404b2, 404c1, 404c2, 404d1, and 404d2. The pointers 408a1 and 408a2 are associated with layer 1 of the neural network. The pointers 408b1 and 408b2 are associated with layer 2 of the neural network. The pointers 408c1 and 408c2 are associated with layer 3 of the neural network. The pointers 408d1 and 408d2 are associated with layer 4 of the neural network. The pointers 408a1, 408b1, 408c1, and 408d1 are associated with active states (which will be described hereinafter). The pointers 408a2, 408b2, 408c2, and 408d2 are associated with extra states (which will be described hereinafter). While the example of FIG. 4 assumes 4 layers in the neural network, it should be appreciated that the neural network may have fewer or more than 4 layers. It should also be appreciated that there may be more or fewer states registers 404, stage registers 406, and pointers 408 depending on how many layers the neural network has.

As referred to herein, a “register” should be understood to mean any portion of a memory that stores the current status of something, such as the current states of a layer or a neural network or a current stage of a layer of a neural network (e.g., the skip, warmup, or transition stages described below).

The processing circuitry 410 may include circuitry configured to perform operations for processing an input through a neural network. Such operations may include addition, multiplication, convolution, and/or other nonlinear functions. The processing circuitry 410 may also include circuitry configured to combine results of neural network processing using different states. The control circuitry 412 may be configured to control operations of the neural network chip 400.

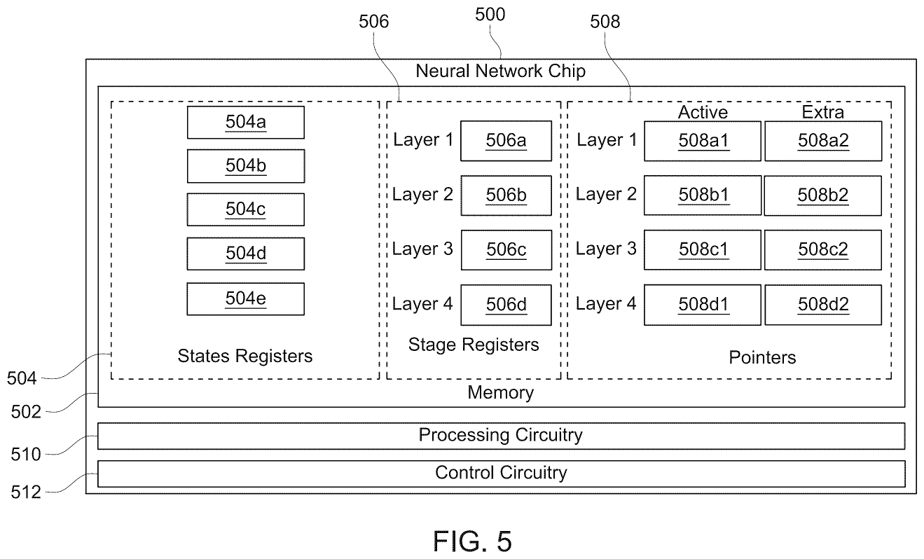

FIG. 5 illustrates a neural network chip 500, in accordance with certain embodiments described herein. The neural network chip 500 includes memory 502, processing circuitry 510 (which may be the same as the processing circuitry 110), and control circuitry 512. It should be appreciated that the neural network chip 500 may include more elements than illustrated. The memory 502 includes a plurality of states registers 504, a plurality of stage registers 506, and a plurality of pointers 508. The states registers 504 include the state registers 504a, 504b, 504c, 504d, and 504e. The stage registers 506 include the stage registers 506a, 506b, 506c, and 506d. The stage register 506a is associated with layer 1 of the neural network. The stage register 506b is associated with layer 2 of the neural network. The stage register 506c is associated with layer 3 of the neural network. The stage register 506d is associated with layer 4 of the neural network. The pointers 508 include the pointers 504a1, 504a2, 504b1, 504b2, 504c1, 504c2, 504d1, and 504d2. The pointers 508a1 and 508a2 are associated with layer 1 of the neural network. The pointers 508b1 and 508b2 are associated with layer 2 of the neural network. The pointers 508c1 and 508c2 are associated with layer 3 of the neural network. The pointers 508d1 and 508d2 are associated with layer 4 of the neural network. The pointers 508a1, 508b1, 508c1, and 508d1 are associated with active states (which will be described hereinafter). The pointers 508a2, 508b2, 508c2, and 508d2 are associated with extra states (which will be described hereinafter). While the example of FIG. 5 assumes 4 layers in the neural network, it should be appreciated that the neural network may have fewer or more than 4 layers. It should also be appreciated that there may be more or fewer states registers 504, stage registers 506, and pointers 508 depending on how many layers the neural network has.

The processing circuitry 510 may include circuitry configured to perform operations for processing an input through a neural network. Such operations may include addition, multiplication, convolution, and/or other nonlinear functions. The processing circuitry 510 may also include circuitry configured to combine results of neural network processing using different states. The control circuitry 512 may be configured to control operations of the neural network chip 500.

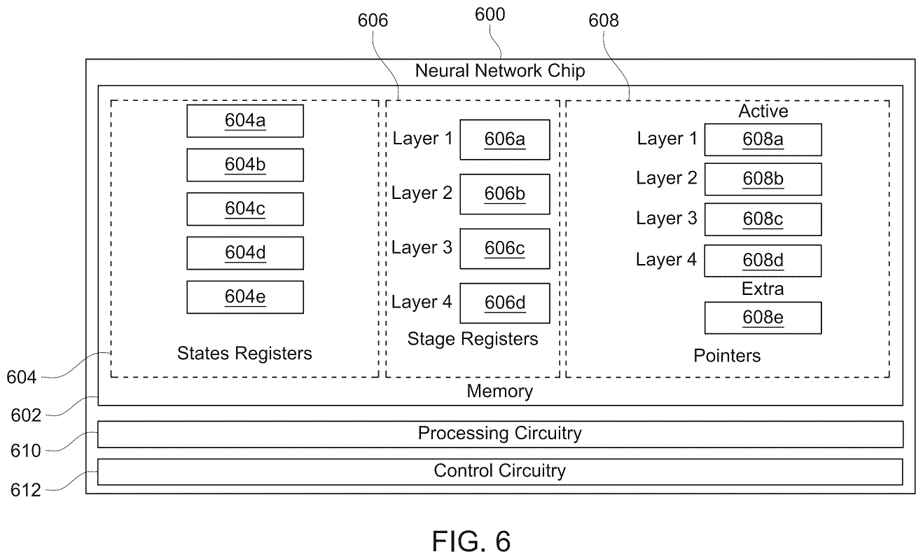

FIG. 6 illustrates a neural network chip 600, in accordance with certain embodiments described herein. The neural network chip 600 includes memory 602, processing circuitry 610 (which may be the same as the processing circuitry 110), and control circuitry 612. It should be appreciated that the neural network chip 60 may include more elements than illustrated. The memory 602 includes a plurality of states registers 604, a plurality of stage registers 606, and a plurality of pointers 608. The states registers 604 include the state registers 604a, 604b, 604c, 604d, and 604e. The stage registers 606 include the stage registers 606a, 606b, 606c, and 606d. The stage register 606a is associated with layer 1 of the neural network. The stage register 606b is associated with layer 2 of the neural network. The stage register 606c is associated with layer 3 of the neural network. The stage register 606d is associated with layer 4 of the neural network. The pointers 608 include the pointers 604a, 604b, 604c, 604d, and 604e. The pointer 608a is associated with active states of layer 1 of the neural network. The pointer 608b is associated with active states of layer 2 of the neural network. The pointer 608c is associated with active states of layer 3 of the neural network. The pointer 608d is associated with active states of layer 4 of the neural network. The pointer 608e is associated with extra states, and those states may be associated with any layer. While the example of FIG. 6 assumes 4 layers in the neural network, it should be appreciated that the neural network may have fewer or more than 4 layers. It should also be appreciated that there may be more or fewer states registers 604, stage registers 606, and pointers 608 depending on how many layers the neural network has.

The processing circuitry 610 may include circuitry configured to perform operations for processing an input through a neural network. Such operations may include addition, multiplication, convolution, and/or other nonlinear functions. The processing circuitry 610 may also include circuitry configured to combine results of neural network processing using different states. The control circuitry 612 may be configured to control operations of the neural network chip 600.

As described above, in certain types of neural networks (e.g., recurrent neural networks (RNNs)), the result of neural network processing at one time step may affect the neural network processing at a subsequent time step. Such neural networks may thus have states that persist from one time step to another and represent context information derived from processing of one or more previous inputs. The states registers (e.g., the states registers 404, 604, and/or 504) may store states for different layers of the neural network. As further described above, it may be helpful to perform neural network processing using extra sets of states to enable resetting of states. Resetting may occur according to a schedule of stages (e.g., the stages described with reference to FIGS. 2 and 3). In some embodiments, there may be three stages: a skip stage, a warmup stage, and a transition stage. In some embodiments, there may be six stages: a skip stage of type 1, a warmup stage of type 1, a transition stage of type 1, a skip stage of type 2, a warmup stage of type 2, and a transition stage of type 2. Each stage register (e.g., the stage registers 406, 606, and/or 506) may store the stage for a layer.

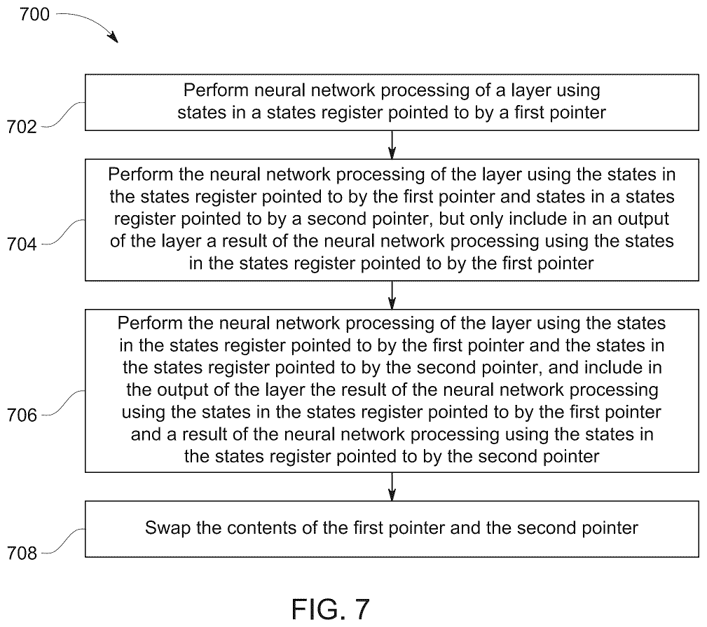

In further detail, in some embodiments the neural network chips 400, 600, and/or 500 may be configured to operate as described by a process 700. FIG. 7 illustrates the process 700 for operating a neural network chip (e.g., the neural network chip 400, 600, and/or 700), in accordance with certain embodiments described herein. The following description will make continuous use of two examples, which will be labeled Example 1 and Example 2. Example 1 may make reference to elements of FIG. 4. Example 2 may make reference to elements of FIG. 5. Example 3 may make reference to elements of FIG. 5. The process 700 generally follows the reset schedule described with reference to FIG. 3.

At step 702, control circuitry (e.g., the control circuitry 412 or 612) in the neural network chip controls processing circuitry (e.g., the processing circuitry 410) in the neural network chip to perform neural network processing of a layer of a neural network (e.g., a recurrent neural network) using states in a states register pointed to by a first pointer. Neural network processing may include any operations for processing an input through a neural network. Such operations may include addition, multiplication, convolution, and/or other nonlinear functions. Step 702 may correspond to a skip stage (e.g., a stage “S” in FIG. 3). The states in the states register pointed to by the first pointer may be the “active” states referred to above.

Example 1: Assume that at step 702, layer 1 (i.e., the “layer”) of a neural network is currently being processed by processing circuitry (e.g., the processing circuitry 410). The pointer 408a1 (i.e., the “first pointer”) may point to the states register 404a1. Then, during the skip stage of step 702, only the states in the states register 404a1 may be used for processing by the processing circuitry 410.

Example 2: Assume that at step 702, layer 1 (i.e., the “layer”) of a neural network is currently being processed by processing circuitry (e.g., the processing circuitry 510). The pointer 508a1 (i.e., the “first pointer”) may point to the states register 504a. Then, during the skip stage of step 702, only the states in the states register 504a may be used for processing by the processing circuitry 510.

Example 3: Assume that at step 702, layer 1 (i.e., the “layer”) of a neural network is currently being processed by processing circuitry (e.g., the processing circuitry 610). The pointer 608a (i.e., the “first pointer”) may point to the states register 604a. Then, during the skip stage of step 702, only the states in the states register 604a may be used for processing by the processing circuitry 610.

At step 704, the control circuitry controls the processing circuitry in the neural network chip to perform the neural network processing of the layer using the states in the states register pointed to by the first pointer and states in a states register pointed to by a second pointer, but only include in an output of the layer a result of the neural network processing using the states in the states register pointed to by the first pointer. Step 704 may correspond to a warmup stage (e.g., a stage “W” in FIG. 3). The states in the states register pointed to by the second pointer may be the “extra” states referred to above. In contrast to step 704, neural network processing of states in the states register pointed to by the second pointer is not performed at step 702.

Example 1: The states in the states register 404a1 pointed to by the pointer 408a1 (i.e., the “first pointer”) may be used for processing by the processing circuitry 410, and then the states in the states register 404a2 pointed to be the pointer 408a2 (i.e., the “second pointer”) may be used for processing by the processing circuitry 410 (or vice versa). Only the result of processing using the states in the states register 404a1 may be included in the output of layer 1.

Example 2: The states in the states register 504a pointed to by the pointer 508a1 (i.e., the “first pointer”) may be used for processing by the processing circuitry 510, and then the states in the states register 504e pointed to be the pointer 508a2 (i.e., the “second pointer”) may be used for processing by the processing circuitry 510 (or vice versa). Only the result of processing using the states in the states register 504a may be included in the output of layer 1.

Example 3: The states in the states register 604a pointed to by the pointer 608a (i.e., the “first pointer”) may be used for processing by the processing circuitry 610, and then the states in the states register 604e pointed to by the pointer 608e (i.e., the “second pointer”) may be used for processing by the processing circuitry 610 (or vice versa). Only the result of processing using the states in the states register 704a may be included in the output of layer 1.

At step 706, the control circuitry controls the processing circuitry in the neural network chip to perform the neural network processing of the layer using the states in the states register pointed to by the first pointer and the states in the states register pointed to by the second pointer, and to include in the output of the layer the result of the neural network processing using the states in the states register pointed to by the first pointer and a result of the neural network processing using the states in the states register pointed to by the second pointer. Step 706 may correspond to a transition stage (e.g., a stage “T” in FIG. 3).

Example 1: The states in the states register 404a1 pointed to by the pointer 408a1 (i.e., the “first pointer”) may be used for processing by the processing circuitry 410, and then the states in the states register 404a2 pointed to be the pointer 408a2 (i.e., the “second pointer”) may be used for processing by the processing circuitry 410 (or vice versa). The result of processing using the states in the states register 404a1 and the result of processing using the states in the states register 404a2 may be included in the output of layer 1.

Example 2: The states in the states register 504a pointed to by the pointer 508a1 (i.e., the “first pointer”) may be used for processing by the processing circuitry 510, and then the states in the states register 504e pointed to be the pointer 508a2 (i.e., the “second pointer”) may be used for processing by the processing circuitry 510 (or vice versa). The result of processing using the states in the states register 504a and the result of processing using the states in the states register 504e may be included in the output of layer 1.

Example 3: The states in the states register 604a pointed to by the pointer 608a (i.e., the “first pointer”) may be used for processing by the processing circuitry 610, and then the states in the states register 604e pointed to be the pointer 608e (i.e., the “second pointer”) may be used for processing by the processing circuitry 610 (or vice versa). The result of processing using the states in the states register 604a and the result of processing using the states in the states register 604e may be included in the output of layer 1.

In some embodiments, the control circuitry may be configured to include the result of the neural network processing using the states in the states register pointed to by the first pointer and the result of the neural network processing using the states in the states register pointed to by the second pointer by performing a weighted sum of the two results. In particular, the control circuitry may be configured to apply a first weight to the result of the neural network processing using the states in the states register pointed to by the first pointer that transitions from 1 to 0 (e.g., between step 706 and step 708), and apply a second weight to the result of the neural network processing using the states in the states register pointed to by the second pointer transitions from 0 to 1 (e.g., between step 706 and step 708). Such a weight schedule is also illustrated in FIG. 3. In example 1, the weight applied to the output from processing the states in the states register 404a1 may start at 1 and transition to 0, while the weight applied to the output from processing the states in the states register 404a2 may start at 0 and transition to 1. In example 2, the weight applied to the output from processing the states in the states register 504a may start at 1 and transition to 0, while the weight applied to the output from processing the states in the states register 504e may start at 0 and transition to 1. In example 3, the weight applied to the output from processing the states in the states register 604a may start at 1 and transition to 0, while the weight applied to the output from processing the states in the states register 604e may start at 0 and transition to 1.

While the examples for steps 704 and 706 have described performing neural network processing on one set of states and then performing neural network processing on another set of states, in some embodiments the neural network processing may be performed simultaneously. For example, there may be more than one instance of the processing circuitry available at a given time.

At step 708, the control circuitry controls the first pointer and the second pointer to swap contents. Additionally, the control circuitry may reset those states that were pointed to by the first pointer during steps 702-706. This may occur before the swapping or after the swapping (i.e., before step 708 or after step 708). If before swapping (i.e., between step 706 and step 708), then the control circuitry may reset the states in the states register pointed to by the first pointer. If after swapping (i.e., after step 708), then the control circuitry may reset the states in the states register pointed to by the second pointer. Thus, the states that were the extra states may become the active states for a subsequent run through the process 700, and the states that were the active states may be reset. As described above, resetting states may refer to actively changing values to 0, or actively changing values to a different value other than zero. Additionally, as referred to herein, resetting states may refer to actively changing values immediately, or over a finite length of time. In the latter case, the reset may be smooth, such that the values decay over time to zero or to a different value. Additionally, resetting states may refer to only resetting certain of the states but not all the states.

Example 1: The pointer 408a1 (i.e., the “first pointer), which previously pointed to the states register 404a1, will now point to the states register 404a2, and the pointer 408a2 (i.e., the “second pointer”) which previously pointed to the states register 404a2, will now point to the states register 404a1. Thus, on a subsequent run through the process 700, when layer 1 is being processed by the processing circuitry 410, at step 702 the states in the states register 404a2 will be used, whereas on the previous run through the process 700, the states in the state register 404a1 were used. The states in the states register 404a1 may be reset.

Example 2: The pointer 508a1 (i.e., the “first pointer), which previously pointed to the states register 504a, will now point to the states register 504e, and the pointer 508a2 (i.e., the “second pointer”) which previously pointed to the states register 504e, will now point to the states register 504a. Thus, on a subsequent run through the process 700, when layer 1 is being processed by the processing circuitry 510, at step 702 the states in the states register 504e will be used, whereas on the previous run through the process 700, the states in the state register 504a were used. The states in the states register 504a may be reset.

Example 3: The pointer 608a (i.e., the “first pointer), which previously pointed to the states register 604a, will now point to the states register 604e, and the pointer 608e (i.e., the “second pointer”) which previously pointed to the states register 604e, will now point to the states register 604a. Thus, on a subsequent run through the process 700, when layer 1 is being processed by the processing circuitry 610, at step 702 the states in the states register 604e will be used, whereas on the previous run through the process 700, the states in the states register 604a were used. The states in the states register 704a may be reset.

It should be appreciated that the steps of the process 700 may begin at different times. Thus, step 702 may begin at a first time, step 704 may begin at a second time subsequent to the second time, step 706 may begin at a third time subsequent to the second time, and step 708 may begin at a fourth time subsequent to the third time.

It should be appreciated that step 702 may last for a first period of time, step 704 may last for a second period of time subsequent to the first period of time, and step 706 may last for a third period of time subsequent to the second period of time.

It should be appreciated that the process 700 may proceed as an ordered sequence, namely step 702 followed by step 704 followed by step 706 followed by step 708.

It may be considered that during step 702, the neural network processing performed by the processing circuitry produces a first set of results; during step 704, the neural network processing performed by the processing circuitry produces a second set of results; and during step 706, the neural network processing performed by the processing circuitry produces a third set of results. The processing circuitry may produce the second set of results subsequent to producing the first set of results, and produce the third set of results subsequent to producing the second set of results. The swap at step 708 may be performed subsequent to producing the third set of results.

In some embodiments, a stage register may store that the layer is in a skip stage at step 702, in a warmup stage at step 704, and in a transition stage at step 706. For example, the stage register 406a (in example 1), the stage register 506a (in example 2), and/or the stage register 606a (in example 3) may store the stage. Based on the stored stage, the control circuitry may perform the control described above with reference to the steps of the process 700.

As described above, the stage registers (e.g., the stage registers 406, 506, and/or 606) may store the stage for each layer. In some embodiments, each stage register may include a counter used to index into a schedule of stages. As an example, consider that the schedule has 8 steps. S S S S S S W T, with “S” indicating a skip stage (i.e., the layer is in step 702), “W” indicating a warmup stage (i.e., the layer is in step 704), and “T” indicating a transition stage (i.e., the layer is in step 706). As described above, a step may extend for multiple runs through the full neural network. The counter for each stage register may count from 0 to 7 and then revert back to 0. The counter value may index into the schedule such that, for example, counter values from 0 to 5 dictate a skip stage, 6 may dictate a warmup stage, and 7 may dictate a transition stage. Using different starting values for the counters in different stage registers may enable different layers to start at different positions in the schedule. In some embodiments, state machines may be used to control progress through the schedule of stages. This may enable different layers to follow different sequences of stages.

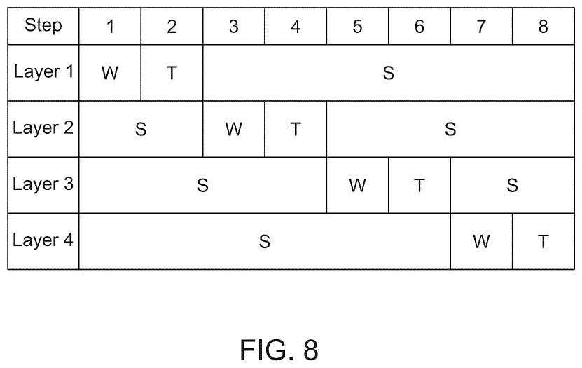

In some embodiments, only one layer may reset at a time. FIG. 8 illustrates an example of schedules for four layers, in which only one layer resets at a time, in accordance with certain embodiments described herein. The schedules of FIG. 8 may follow the schedule of FIG. 3, which includes three types of stages. If a reset is considered to occur at the end of a transition stage, then as can be seen, each layer resets at different times. When not in warmup or transition stages, a layer is in a skip stage. The period of the schedule is 8 steps, where a step is a certain number of runs through the neural network. A reset occurs every 8 steps in this example. It should be appreciated that the schedule may be modified based on how many layers are in the neural network. For example, with three layers, resets for a given layer may occur every 6 steps. With five layers, resets for a given layer may repeat every 10 steps.

If a reset is considered to occur at the end of a transition stage, then in some embodiments, a time from the end of a transition stage to the end of a subsequent transition stage is in a range of 1-30 seconds. In some embodiments, a time from the beginning of a warmup stage to the end of an immediately following transition stage is in a range of 0.25-3 seconds.

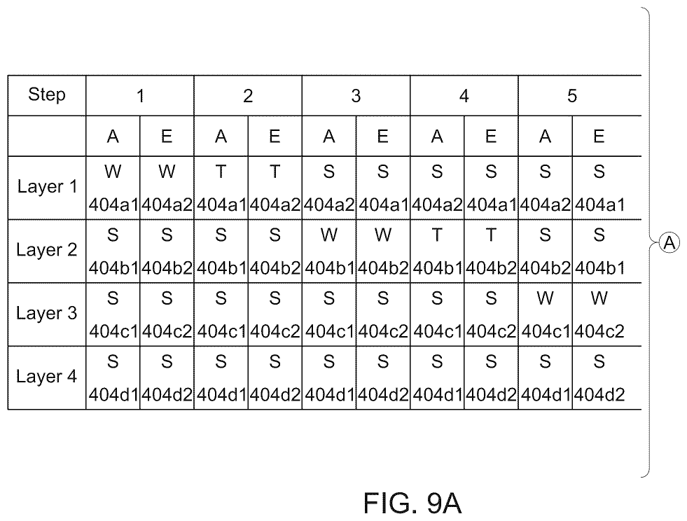

FIG. 9 illustrates an example, with reference to FIG. 4, of which states registers 404 the pointers 408 point to assuming the process 700 and the schedule of FIG. 8 are followed, in accordance with certain embodiments described herein. In particular, FIG. 9 illustrates, for each layer, an example of which states registers 404 contain the active (“A”) states and which states registers 404 contain the extra (“E”) states. For example, at a given step, the states register pointed to by the pointer 408a1 (which points to layer's 1 active states) is in the “Layer 1” row and the “A” column. The states register pointed to by the pointer 408a2 (which points to layer's 1 extra states) is in the “Layer 1” row and the “E” column, etc. It should be appreciated that, as described and illustrated above, the pointers 408 for a particular layer may swap after the transition stage. For example, during step 2, when layer 1 is in the transition stage, the pointer 408a1 points to the states register 404a1, and the pointer 408a2 points to the states register 404a2. Following the transition stage, at step 3, the pointer 408a1 points to the states register 404a2, and the pointer 408a2 points to the states register 404a1.

It should also be appreciated that, while the above examples describe layers resetting at different times, because each layer has two states registers 404, one for the active states and one for the extra states, multiple layers may reset at the same time. In other words, the schedule of stages for each layer may be independent.

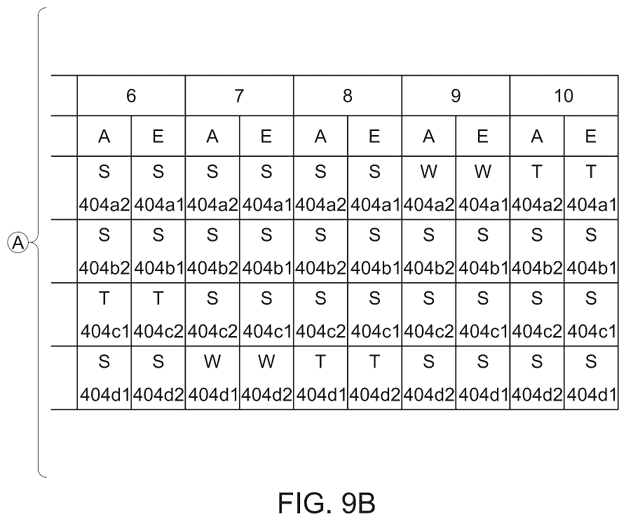

FIG. 10 illustrates an example, with reference to FIG. 5, of which states registers 504 the pointers 508 point to assuming the process 700 and the schedule of FIG. 8 are followed, in accordance with certain embodiments described herein. For example, at step 1, the states register pointed to by the pointer 508a1 (which points to layer's 1 active states) is in the “Layer 1” row. The states register pointed to by the pointer 508a2 (which points to the extra states) is in the “Extra” row. It should be appreciated that, as described and illustrated above, the contents of the pointer for a particular layer's active states and the pointer for the extra states may swap after that layer's transition stage. For example, during step 2, when layer 1 is in transition stage, the states register 504a stores the active states for layer 1, and the states register 504e stores the extra states for layer 1. After layer 1's transition stage, during step 3, the states register 504e stores the active states for layer 1, and the states register 504a stores the extra states (which have been reset in preparation for resetting a subsequent layer). During step 4, when layer 2 is in transition stage, the states register 504b stores the active states for layer 2, and the states register 504a stores the extra states for layer 2. After layer 2's transition stage, during step 5, the states register 504a stores the active states for layer 2, and the states register 504b stores the extra states (which have been reset in preparation for resetting a subsequent layer). It should be appreciated that the pointers for each layer's extra states (i.e., the pointers 508a2, 508b2, 508c2, 508d2, and 508e2) may always point to the same states register 504.

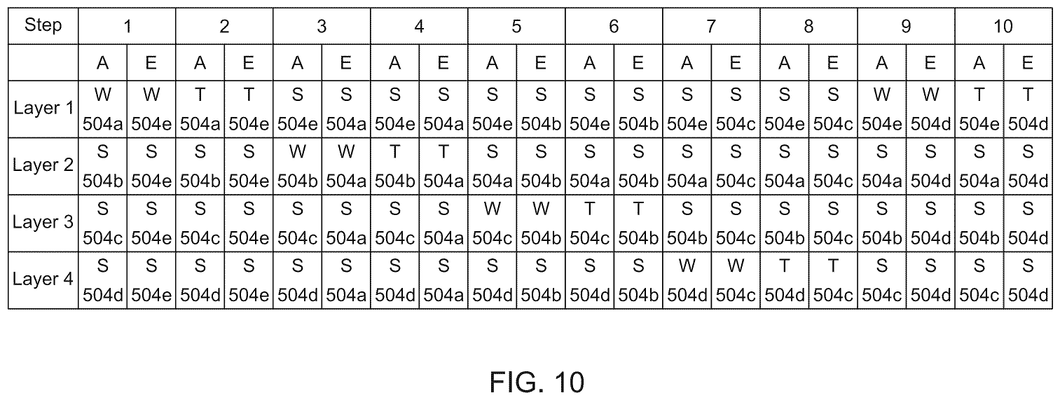

FIG. 11 illustrates an example, with reference to FIG. 6, of which states registers 604 the pointers 608 point to assuming the process 700 and the schedule of FIG. 8 are followed, in accordance with certain embodiments described herein. For example, at step 1, the states register pointed to by the pointer 608a (which points to layer's 1 active states) is in the “Layer 1” row. The states register pointed to by the pointer 608e (which points to the extra states) is in the “Extra” row. It should be appreciated that, as described and illustrated above, the contents of the pointer for a particular layer's active states and the pointer for the extra states may swap after that layer's transition stage. For example, during step 2, when layer 1 is in transition stage, the states register 604a stores the active states for layer 1, and the states register 604e stores the extra states for layer 1. After layer 1's transition stage, during step 3, the states register 604e stores the active states for layer 1, and the states register 604a stores the extra states (which have been reset in preparation for resetting a subsequent layer). During step 4, when layer 2 is in transition stage, the states register 604b stores the active states for layer 2, and the states register 604a stores the extra states for layer 2. After layer 2's transition stage, during step 5, the states register 604a stores the active states for layer 2, and the states register 604b stores the extra states (which have been reset in preparation for resetting a subsequent layer).

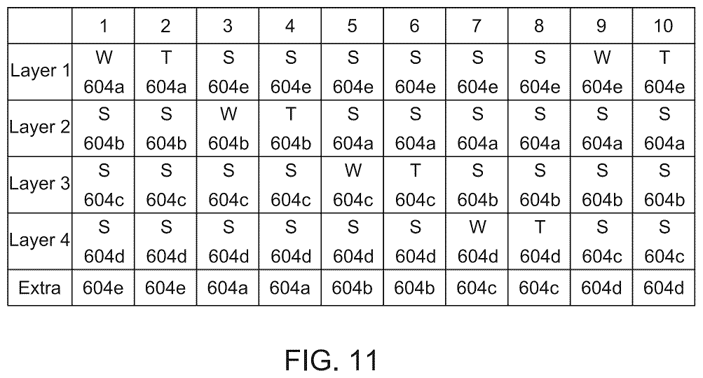

In some embodiments, the neural network chips 400, 500, and/or 600 may be configured to operate as described by a process 1200. FIG. 12 illustrates the process 1200 for operating a neural network chip (e.g., the neural network chip 400, 500, and/or 600), in accordance with certain embodiments described herein. The process 1200 generally follows the reset schedule described with reference to FIG. 3.

Steps 1202-1206 are the same as steps 702-706. The description of steps 702-706, and the examples 1-3, apply to the steps 1202-1206. At step 1208, the control circuitry may control the states in the states register pointed to by the first pointer to be replaced with the states in the states register pointed to by the second pointer. Subsequently, the control circuitry may reset those states in the states register pointed to by the second pointer.

Example 1: The states in the states register 404a1 will be replaced by the states in the states register 404a2. Then, the states in the states register 404a2 may be reset. Thus, on a subsequent run through the process 1200, when layer 1 is being processed by the processing circuitry 410, at step 1202 the states in the states register 404a1 may be used, and those states may be states that were in the states register 404a2 during the previous run through the process 1200.

Example 2: The states in the states register 504a will be replaced by the states in the states register 504e. Then, the states in the states register 504e may be reset. Thus, on a subsequent run through the process 1200, when layer 1 is being processed by the processing circuitry 410, at step 1202 the states in the states register 504a may be used, and those states may be states that were in the states register 504e during the previous run through the process 1200.

Example 3: The states in the states register 604a will be replaced by the states in the states register 604e. Then, the states in the states register 604e may be reset. Thus, on a subsequent run through the process 1200, when layer 1 is being processed by the processing circuitry 410, at step 1202 the states in the states register 604a may be used, and those states may be states that were in the states register 604e during the previous run through the process 1200.

It should be appreciated that the steps of the process 1200 may begin at different times. Thus, step 1202 may begin at a first time, step 1204 may begin at a second time subsequent to the second time, step 1206 may begin at a third time subsequent to the second time, and step 1208 may begin at a fourth time subsequent to the third time.

It should be appreciated that step 1202 may last for a first period of time, step 1204 may last for a second period of time subsequent to the first period of time, and step 1206 may last for a third period of time subsequent to the second period of time.

It should be appreciated that the process 1200 may proceed as an ordered sequence, namely step 1202 followed by step 1204 followed by step 1206 followed by step 1208.

It may be considered that during step 1202, the neural network processing performed by the processing circuitry produces a first set of results; during step 1204, the neural network processing performed by the processing circuitry produces a second set of results; and during step 1206, the neural network processing performed by the processing circuitry produces a third set of results. The processing circuitry may produce the second set of results subsequent to producing the first set of results, and produce the third set of results subsequent to producing the second set of results. The replacement at step 1208 may be performed subsequent to producing the third set of results.

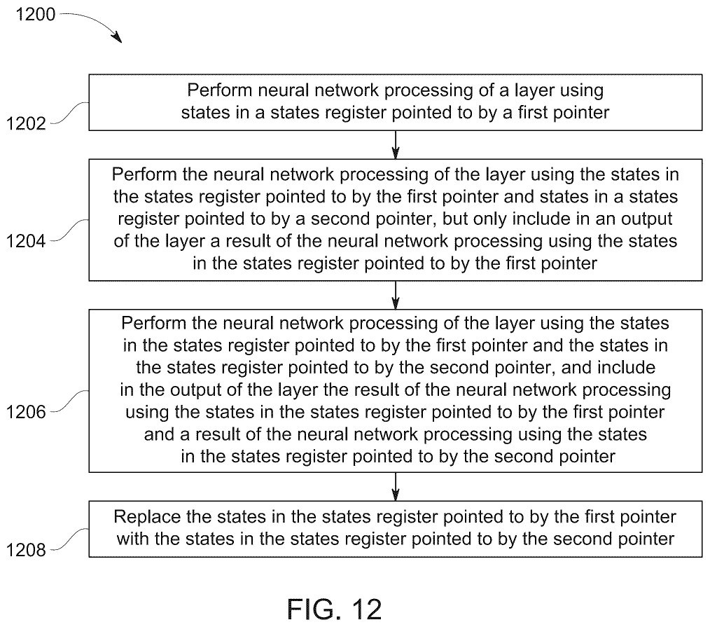

In some embodiments, the neural network chips 400, 500, and/or 600 may be configured to operate as described by a process 1300. FIGS. 13A and 13B illustrate the process 1300 for operating a neural network chip (e.g., the neural network chip 400, 500, and/or 600), in accordance with certain embodiments described herein. The process 1300 generally follows the reset schedule described with reference to FIG. 2.

Steps 1302-1306 are the same as steps 702-706. The description of steps 702-706, and the examples 1 and 2, apply to the steps 1302-1306. Step 1302 may correspond to the stage “S1” in FIG. 2, step 1304 may correspond to the stage “W1” in FIG. 2, and step 1306 may correspond to the stage “T1” in FIG. 2. It should be appreciated that steps 1308-1312 are the inverse of steps 1302-1306, with the first pointer replacing the second pointer and the second pointer replacing the first pointer. Thus, the examples 1-3 provided above for steps 702-706 may be inverted to correspond to steps 1308-1312. Step 1308 may correspond to stage “S2” in FIG. 2, step 1310 may correspond to stage “W2” in FIG. 2, and step 1312 may correspond to stage “T2” in FIG. 2.

It should be appreciated that following step 1306, those states pointed to by the first pointer may be reset, and following step 1312, those states pointed to by the second pointer may be reset. As described above, resetting states may refer to actively changing values to 0, or actively changing values to a different value other than zero. Additionally, as referred to herein, resetting states may refer to actively changing values immediately, or over a finite length of time. In the latter case, the reset may be smooth, such that the values decay over time to zero or to a different value. Additionally, resetting states may refer to only resetting certain of the states but not all the states.

It should be appreciated that the steps of the process 1300 may begin at different times. Thus, step 1302 may begin at a first time, step 1304 may begin at a second time subsequent to the second time, step 1306 may begin at a third time subsequent to the second time, step 1308 may begin at a fourth time subsequent to the third time, step 1310 may begin at a fifth time subsequent to the fourth time, and step 1312 may begin at a sixth time subsequent to the fifth time.

It should be appreciated that step 1302 may last for a first period of time, step 1304 may last for a second period of time subsequent to the first period of time, step 1306 may last for a third period of time subsequent to the second period of time, step 1308 may last for a fourth period of time subsequent to the third period of time, step 1310 may last for a fifth period of time subsequent to the fourth period of time, and step 1312 may last for a sixth period of time subsequent to the fifth period of time.

It should be appreciated that the process 1300 may proceed as an ordered sequence, namely step 1302 followed by step 1304 followed by step 71306 followed by step 1308 followed by step 1310 followed by step 1310.

It may be considered that during step 1302, the neural network processing performed by the processing circuitry produces a first set of results; during step 1304, the neural network processing performed by the processing circuitry produces a second set of results; during step 1306, the neural network processing performed by the processing circuitry produces a third set of results; during step 1308, the neural network processing performed by the processing circuitry produces a fourth set of results; during step 1310, the neural network processing performed by the processing circuitry produces a fifth set of results; and during step 1312, the neural network processing performed by the processing circuitry produces a sixth set of results. The processing circuitry may produce the second set of results subsequent to producing the first set of results, produce the third set of results subsequent to producing the second set of results, produce the fourth set of results subsequent to producing the third set of results, produce the fifth set of results subsequent to producing the fourth set of results, and produce the sixth set of results subsequent to producing the fifth set of results.

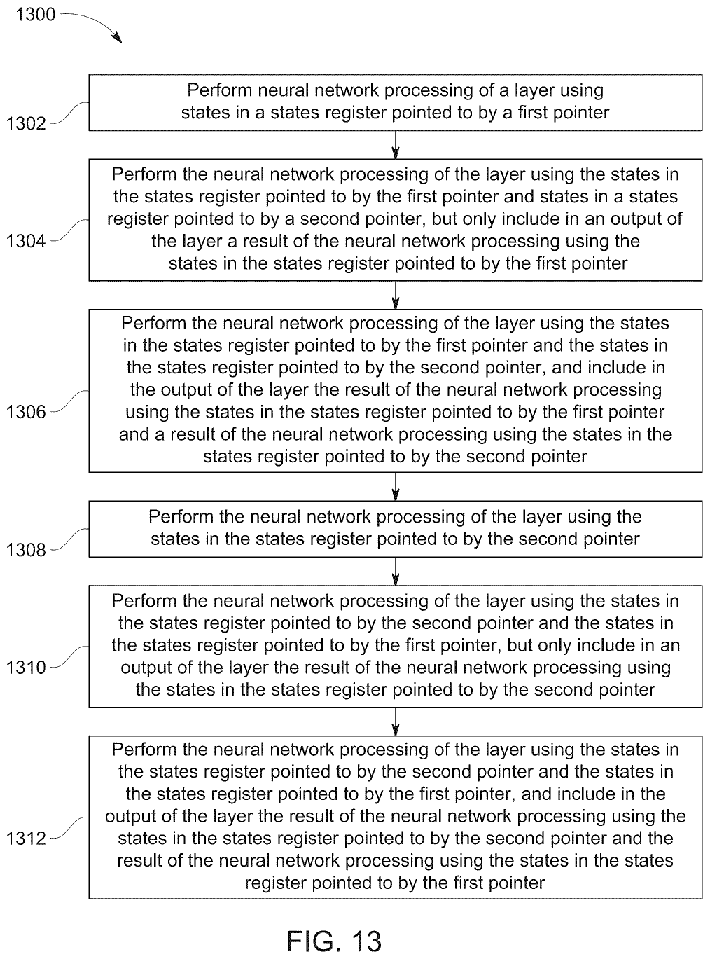

FIG. 14 illustrates an example of schedules for four layers, in which only one layer resets at a time, in accordance with certain embodiments described herein. The schedules of FIG. 14 follow the schedule of FIG. 2, which includes six types of stages. As can be seen, each layer is in a warmup stage “W1” or “W2” followed by a transition stage “T1” or “T2” (in other words, each layer resets) at different times. When not in warmup or transition stages, a layer is in a skip stage. The period of the schedule is 16 steps, where a step is a certain number of runs through the neural network. A reset occurs every 8 steps in this example. It should be appreciated that the schedule may be modified based on how many layers are in the neural network. For example, with three layers, resets for a given layer may occur every 6 steps. With five layers, resets for a given layer may repeat every 10 steps.

If a reset is considered to occur at the end of a transition stage, then in some embodiments, a time from the end of a transition stage to the end of a subsequent transition stage (e.g., from the end of a “T1” stage to the end of a “T2” stage, or vice versa) is in a range of 1-30 seconds. For example, in the process 1300, step 1306 may be during a first transition stage and step 1312 may be during a second transition stage, and a time between the end of the first transition stage to the end of the second transition stage for the layer may be in a range of 1-30 seconds. In some embodiments, a time from the beginning of a warmup stage to the end of an immediately following transition stage is in a range of 0.25-3 seconds.

In some embodiments, a neural network chip (e.g., the neural network chip 400, 500, and/or 600) may be running a neural network with N layers. Due to two sets of states (active and extra) being used for neural network processing during a layer's warmup and transition stages, the processing circuitry (e.g., the processing circuitry 410, 510, and/or 610) of the neural network chip may always be running the equivalent of N+1 layers. Thus, the reset schedules described herein may involve the neural network chip being configured to use an additional 100/N (or approximately 100/N) percent computing time compared to running the N-layer neural network without any resetting.

It should be appreciated from the above discussion that a neural network chip (e.g., the neural network chip 400, 500, and/or 600) may include memory (e.g., the memory 402, 502, and/or 602) including states registers (e.g., the states registers 404, 504, and/or 604), processing circuitry (e.g., the processing circuitry 410, 510, and/or 610), and control circuitry (e.g., the control circuitry 412, 512, and/or 612). The control circuitry may be configured to control the processing circuitry to perform neural network processing of an N-layer neural network using more than N states registers. For example, the neural network chip 400 may be configured to perform neural network processing of a 4-layer neural network using 8 states registers 404. The neural network chip 500 may be configured to perform neural network processing of a 4-layer neural network using 5 states registers 504. The neural network chip 600 may be configured to perform neural network processing of a 4-layer neural network using 5 states registers 604.

In some embodiments, the memory may further include stage registers (e.g., the stage registers 406, 506, and/or 606). The number of stage registers used during neural network processing of an N-layer neural network may be equal to the number of layers in the neural network. The number of stage registers may be less than the number of states registers.

It should be appreciated from the above discussion that a neural network chip (e.g., the neural network chip 400, 500, and/or 600) may include memory (e.g., the memory 402, 502, and/or 602) including states registers (e.g., the states registers 404, 504, and/or 604) and pointers (e.g., the pointers 408, 508, and/or 608), processing circuitry (e.g., the processing circuitry 410, 510, and/or 610), and control circuitry (e.g., the control circuitry 412, 512, and/or 612). In some embodiments, the control circuitry may be configured to control a first pointer of the plurality of pointers and a second pointer of the plurality of pointers to swap contents (e.g., as described with reference to the process 700).

It should be appreciated from the above discussion that a neural network chip (e.g., the neural network chip 400, 500, and/or 600) may include memory (e.g., the memory 402, 502, and/or 602) including states registers (e.g., the states registers 404, 504, and/or 604), processing circuitry (e.g., the processing circuitry 410, 510, and/or 610), and control circuitry (e.g., the control circuitry 412, 512, and/or 612). In some embodiments, the control circuitry may be configured to control states in a first of the states registers to be replaced with states in a second states register (e.g., as described with reference to the process 1200).

The neural network chip 400, the neural network chip 500, and/or the neural network chip 600 may be implemented in any type of apparatus. In some embodiments, the neural network chip 400, the neural network chip 500, and/or the neural network chip 600 may be implemented in an ear-worn device, such as a hearing aid, cochlear implant, or earphone. In such embodiments, the neural network having layers that are reset as described herein may be trained for speech enhancement and/or noise reduction.

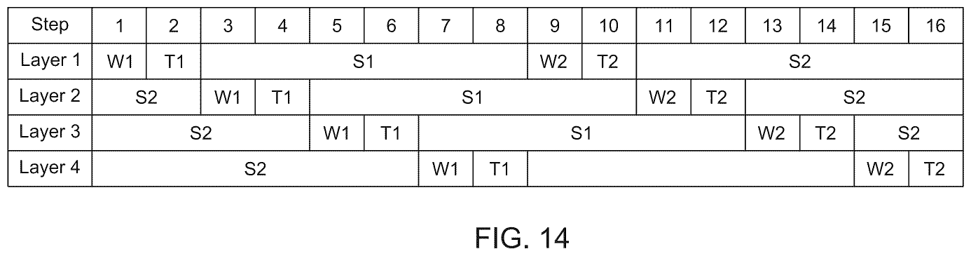

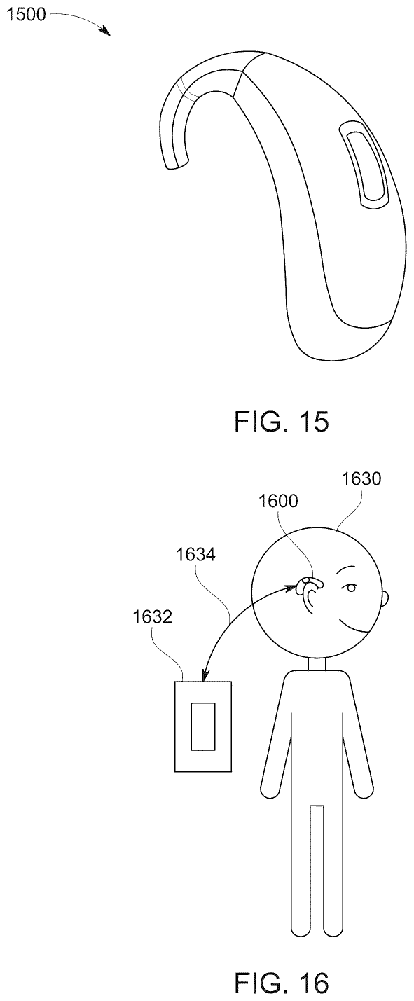

As described above, in some embodiments the neural network chip 400, the neural network chip 500, and/or the neural network chip 600 may be implemented in a hearing aid. FIG. 15 illustrates an example hearing aid 1500, in accordance with certain embodiments described herein. FIG. 16 illustrates an example of a hearing aid 1600 worn by a user 1630, in accordance with certain embodiments described herein. FIG. 16 further illustrates a processing device 1632 and a wireless connection 1634. The processing device 1632 may be used by the user 1630 and may be, for example, a phone, watch, tablet, or processing device dedicated for use with the hearing aid 1600. The wireless connection 1634, which may be, for example, a Bluetooth, WiFi, LTE (Long-Term Evolution), or NFMI (Near-field magnetic induction) connection, connects the processing device 1632 and the hearing aid 1600 such that the processing device 1632 is in operative communication with the hearing aid 1600. Thus, the processing device 1632 may transmit commands to the hearing aid 1600 to configure it and control its operation, and the processing device 1632 may also receive communication from the hearing aid 1600, such as information about the hearing aid 1600's status. It should be appreciated that while for simplicity, a single hearing aid 1600 is illustrated on one ear of the user 1630, another hearing aid may be worn on the other ear of the user 1630. The wireless connection 1634 may be a single connection connecting the processing device 1632 to each of the hearing aids, or may include two individual wireless connections, each connecting to one hearing aid.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

The invention claimed is:

1. An ear-worn device comprising:
a neural network chip comprising:
memory comprising:
a plurality of states registers; and
a plurality of pointers;
processing circuitry; and
control circuitry;
wherein the control circuitry is configured:
at a first time, to control the processing circuitry to perform neural network processing of a layer of a neural network using states in a states register pointed to by a first pointer, wherein the states register pointed to by the first pointer is among the plurality of states registers, and the first pointer is among the plurality of pointers;
at a second time subsequent to the first time, to control the processing circuitry to perform the neural network processing of the layer using the states in the states register pointed to by the first pointer and states in a states register pointed to by a second pointer, but only to include in an output of the layer a result of the neural network processing using the states in the states register pointed to by the first pointer, wherein the states register pointed to by the second pointer is among the plurality of states registers, and the second pointer is among the plurality of pointers;
at a third time subsequent to the second time, to control the processing circuitry to perform the neural network processing of the layer using the states in the states register pointed to by the first pointer and the states in the states register pointed to by the second pointer, and to include in the output of the layer the result of the neural network processing using the states in the states register pointed to by the first pointer and a result of the neural network processing using the states in the states register pointed to by the second pointer; and
at a fourth time subsequent to the third time, to:
control the first pointer and the second pointer to swap contents; or
control the states in the states register pointed to by the first pointer to be replaced with the states in the states register pointed to by the second pointer.

2. The ear-worn device of claim 1, wherein the control circuitry is further configured:
subsequent to the fourth time, to reset the states in the states register pointed to by the second pointer, or
between the third and the fourth times, to reset the states in the states register pointed to by the first pointer.

3. The ear-worn device of claim 1, wherein:
the memory further comprises a plurality of stage registers;
the layer is in a skip stage at the first time, is in a warmup stage at the second time, and is in a transition stage at the third time; and
the stage register is configured to store that the layer is in the skip stage at the first time, in the warmup stage at the second time, and in the transition stage at the third time.

4. The ear-worn device of claim 1, wherein:
the control circuitry is further configured, at the third time, to perform a weighted sum of the result of the neural network processing using the states in the states register pointed to by the first pointer and the result of the neural network processing using the states in the states register pointed to by the second pointer by:
applying a first weight to the result of the neural network processing using the states in the states register pointed to by the first pointer that transitions from 1 to 0 between the third time and the fourth time; and
applying a second weight to the result of the neural network processing using the states in the states register pointed to by the second pointer transitions from 0 to 1 between the third time and the fourth time.

5. The ear-worn device of claim 1, wherein the layer is in a transition stage at the third time, and a time between an end of the transition stage to an end of a subsequent transition stage for the layer is in a range of 1-30 seconds.

6. The ear-worn device of claim 1, wherein the layer is in a warmup stage at the second time and a transition stage at the third time, and a time from a beginning of the warmup stage to an end of the transition stage is in a range of 0.25-3 seconds.

7. The ear-worn device of claim 1, wherein:
the layer comprises a first layer of the neural network;
the neural network comprises a second layer; and
the neural network chip is configured to reset the first layer and the second layer at different times.

8. The ear-worn device of claim 1, wherein the neural network comprises a recurrent neural network.

9. The ear-worn device of claim 1, wherein the processing circuitry does not perform the neural network processing using the states in the states register pointed to by the second register at the first time.

10. The ear-worn device of claim 1, wherein the neural network comprises N layers, and the neural network chip is configured to use an additional 100/N percent computing time compared to running the N-layer neural network without any resetting.

11. An ear-worn device comprising:
a neural network chip comprising:
memory comprising:
a plurality of states registers; and
a plurality of pointers;
processing circuitry; and
control circuitry;
wherein the control circuitry is configured:
at a first time, to control the processing circuitry to perform neural network processing of a layer of a neural network using states in a states register pointed to by a first pointer, wherein the states register pointed to by the first pointer is among the plurality of states registers, and the first pointer is among the plurality of pointers;
at a second time subsequent to the first time, to control the processing circuitry to perform the neural network processing of the layer using the states in the states register pointed to by the first pointer and states in a states register pointed to by a second pointer, but only to include in an output of the layer a result of the neural network processing using the states in the states register pointed to by the first pointer, wherein the states register pointed to by the second pointer is among the plurality of states registers, and the second pointer is among the plurality of pointers;
at a third time subsequent to the second time, to control the processing circuitry to perform the neural network processing of the layer using the states in the states register pointed to by the first pointer and the states in the states register pointed to by the second pointer, and to include in the output of the layer the result of the neural network processing using the states in the states register pointed to by the first pointer and a result of the neural network processing using the states in the states register pointed to by the second pointer;
at a fourth time subsequent to the third time, to control the processing circuitry to the perform neural network processing of the layer of the neural network using the states in the states register pointed to by the second pointer,
at a fifth time subsequent to the fourth time, to control the processing circuitry to perform the neural network processing of the layer using the states in the states register pointed to by the second pointer and the states in the states register pointed to by the first pointer, but only to include in the output of the layer the result of the neural network processing using the states in the states register pointed to by the second pointer, and
at a sixth time subsequent to the fifth time, to control the processing circuitry to perform the neural network processing of the layer using the states in the states register pointed to by the second pointer and the states in the states register pointed to by the first pointer, and to include in the output of the layer the result of the neural network processing using the states in the states register pointed to by the first second and the result of the neural network processing using the states in the states register pointed to by the first pointer.

12. The ear-worn device of claim 11, wherein the control circuitry is further configured, subsequent to the fourth time, to reset the states in the states register pointed to by the first pointer.

13. The ear-worn device of claim 11, wherein:
the memory further comprises a plurality of stage registers;
the layer is in a skip stage at the first time, is in a warmup stage at the second time, and is in a transition stage at the third time; and
the stage register is configured to store that the layer is in the skip stage at the first time, in the warmup stage at the second time, and in the transition stage at the third time.

14. The ear-worn device of claim 11, wherein:
The control circuitry is further configured, at the third time, to perform a weighted sum of the result of the neural network processing using the states in the states register pointed to by the first pointer and the result of the neural network processing using the states in the states register pointed to by the second pointer by:
applying a first weight to the result of the neural network processing using the states in the states register pointed to by the first pointer that transitions from 1 to 0 between the third time and the fourth time; and
applying a second weight to the result of the neural network processing using the states in the states register pointed to by the second pointer transitions from 0 to 1 between the third time and the fourth time.

15. The ear-worn device of claim 11, wherein the layer is in a first transition stage at the third time and in a second transition stage at the sixth time, and a time between an end of the first transition stage to an end of the second transition stage for the layer is in a range of 1-30 seconds.

16. The ear-worn device of claim 11, wherein the layer is in a warmup stage at the second time and a transition stage at the third time, and a time from a beginning of the warmup stage to an end of the transition stage is in a range of 0.25-3 seconds.

17. The ear-worn device of claim 11, wherein:
the layer comprises a first layer of the neural network;
the neural network comprises a second layer; and
the neural network chip is configured to reset the first layer and the second layer at different times.

18. The ear-worn device of claim 11, wherein the neural network further comprises a recurrent neural network.

19. The ear-worn device of claim 11, wherein the processing circuitry does not perform the neural network processing using the states in the states register pointed to by the second register at the first time.

20. The ear-worn device of claim 11, wherein the neural network further comprises N layers, and the neural network chip is configured to use an additional 100/N percent computing time compared to running the N-layer neural network without any resetting.
